(19) United States
(12) Patent Application Publication
(10) Pub. No.: US 2019/0265125 A1
(43) Pub. Date: Aug. 29, 2019

(54) LARGE TEST AREA COMPRESSED AIR WIND TUNNEL

(71) Applicant: Global Reach Aerospace LLC, Austin, TX (US)

(72) Inventor: Preston Henry Carter, Austin, TX (US)

(21) Appl. No.: 16/284,973

(22) Filed: Feb. 25, 2019

Related U.S. Application Data
(60) Provisional application No. 62/634,281, filed on Feb. 23, 2018.
(60) Provisional application No. 62/634,297, filed on Feb. 23, 2018.

(51) Int. Cl. G01M 9/04; B64F 5/60

(52) U.S. Cl. CPC G01M 9/04; B64F 5/60

(57) ABSTRACT

Provided is a wind tunnel system capable of supporting high velocity applications and methods for constructing the same. Some aspects include a sub-surface storage space for storing large volumes of air for one or more of extended testing times, large test sections, and supersonic airspeeds. Some aspects include test sections sized for use with full scale sections of aircraft or major aircraft parts. Some embodiments store air at a constant volume and some sore at a constant pressure. Some embodiments include the use of cavities that appear as a result of industrial or geologic processes, including salt domes and abscesses remaining after carbon extraction.

### CROSS-REFERENCE TO RELATED APPLICATIONS

This application claims priority to U.S. Provisional Application No. 62/634,892, filed Feb. 23, 2018, entitled LARGE TEST AREA COMPRESSED AIR WIND TUNNEL, and U.S. Provisional Application No. 62/634,297 entitled SUPERSONIC HYDROGEN FUEL TURBOJET ENGINE, filed Feb. 23, 2018.

### BACKGROUND

### 1. Field

The present disclosure generally relates to wind tunnels, and more specifically to large test area, compressed-air powered wind tunnels.

### 2. Description of the Related Art

Supersonic testing facilities are extremely expensive for a number of reasons, particularly because of the physical and industrial challenges related to the extreme nature of the underlying physics. The development of high-speed aircraft, and the engines that propel them, require supersonic wind tunnels of various types. The development of supersonic aircraft and engines are stifled by the limited availability, or existence, of suitable wind tunnel capability. In particular, engine wind tunnels with test sections, flow conditions, and long test duration, required for full scale engine testing, are not available. This short fall of capability drive development efforts to subscale and short duration testing. This is adequate for research and development efforts, but limiting for operational vehicle development. This type of testing does not address many critical engineering questions and leaves development efforts with uncertainty and risk that must be explored during flight tests, at great expense.

Large supersonic wind tunnels require enormous power to run and require large pressure ratios and temperature ratios to produce the desired flight conditions in the tunnel test section. Supersonic flow is achieved by passing high pressure and high temperature air through a sonic throat and expanding the flow to the desired Mach number in the Test Section.

The size of the required pressure ratio and temperature ratio becomes an engineering challenge the higher the test Mach number becomes. If the desired test conditions are M₀, T₀, and P₀, the pressure and temperature ratio of the flow between the total pressure and temperature of the air before the sonic throat and the Test Section are:

$${T}_{T} = {T}_{0} ( 1 + \frac{γ - 1}{2} {M}_{0}^{2} ) , \\ τ = ( 1 + \frac{γ - 1}{2} {M}_{0}^{2} )$$

$${P}_{T} = {{P}_{0} ( 1 + \frac{γ - 1}{2} {M}_{0}^{2} )}^{\frac{γ + 1}{γ}} , \\ π = {( 1 + \frac{γ - 1}{2} {M}_{0}^{2} )}^{\frac{γ + 1}{γ}}$$

As shown in FIG. 1, the temperature ratios, pressure ratios increase greatly as Mach number and altitude increase. As a result, the power required to run a supersonic wind tunnel is enormous.

This level of power is usually not readily available, so wind tunnels of this class operate intermittently using energy stored in high-pressure tanks, and heat added to the air before passing through the sonic throat, to run for short duration and over a small test section. A schematic of this configuration of intermittent and/or small test area wind tunnel is shown in FIG. 2. The nozzle, throat, test section, and diffuser are connected and arranged such that gases can flow through the wind tunnel at supersonic speeds.

The physical size of the air storage volume is a limiting factor. For longer duration and for a larger test section, extremely large high-pressure air storage volumes are required. This usually presents a size and cost limitation upon the facility that results in limiting both the scale and the duration of testing that can be provided.

### SUMMARY

The following is a non-exhaustive listing of some aspects of the present techniques. These and other aspects are described in the following disclosure.

Some aspects include a large test section, long-operating supersonic wind tunnel capable of operating for extended periods of time.

Some aspects include a wind tunnel sourced with compressed air stored in underground cavities or abscesses, leveraging already-existing cavities and abscesses including abscesses in salt domes and vacancies from underground carbon extractions or other industrial or geologic processes.

Some aspects include a wind tunnel sized for testing 1:1 scale major portions or subsections of supersonic aircraft, including, e.g., engines, at airflow speeds between Mach 4 and Mach 5.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is an array of relevant graphs showing the interrelationship between pressure, temperature, altitude, and Mach number.

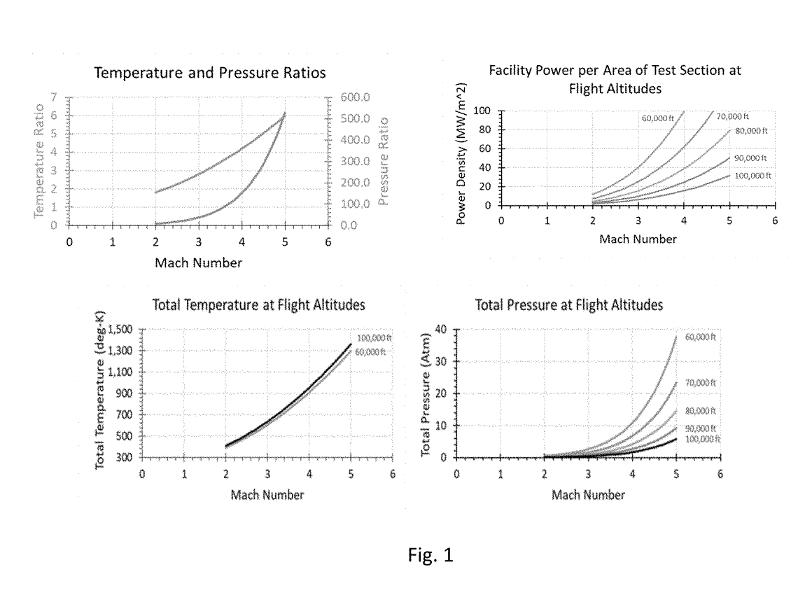

FIG. 2 is a schematic of a prior art wind tunnel.

FIG. 3 is a schematics of a constant volume storage case utilizing an underground gas reservoir and a constant pressure case utilizing an underground gas reservoir.

FIG. 4 is a schematic of an embodiment of a supersonic wind tunnel according to the techniques taught herein, with the gas supply originating from subsurface formations wherein the gas is maintained at constant pressure or constant volume.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of aerospace engineering and wind tunnels. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

The applicant has identified the advantage of using Hydrogen fuel for high-speed, long-range flight. Using Hydrogen fuel in air-breathing engines, at high-Mach numbers, including Mach 4-5, enables rapid travel over intercontinental distances achievable under providing various benefits, including, e.g., supersonic travel at prices comparable to today's subsonic commercial airline travel, supersonic travel available to high-priority uses or high-end customers, and supersonic delivery of cargo. Developing high-speed, Hydrogen fueled engines is one of the necessary technologies that must be refined to make this capability possible. To develop new engines of this type, new test facilities must be developed to allow robust testing and evaluation of engines at full scale and for long enough duration sufficient to support deployment of a fleet of new high-speed airliners. Some aspects of this disclosure describe the design of high-speed wind tunnels for aerodynamic and propulsive testing of engines and aircraft systems at flow conditions and for testing durations necessary for this task.

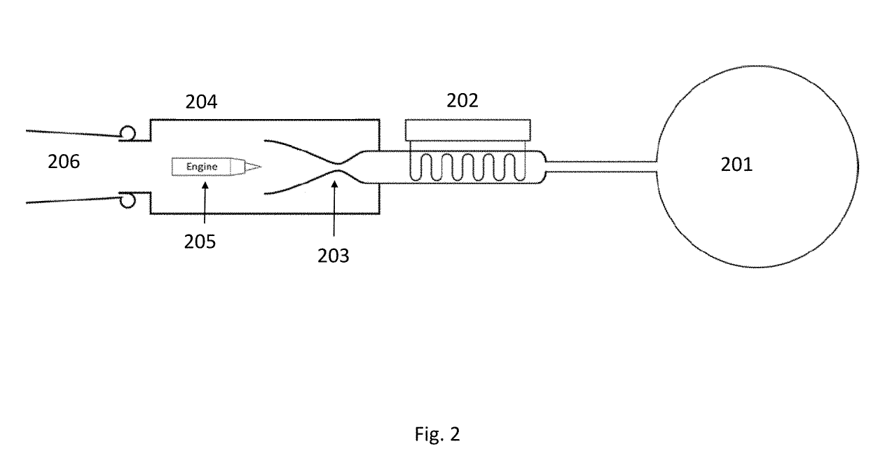

The present disclosure leverages supersonic wind tunnels having a variety of arrangements with additional air supplies. A typical arrangement is shown in FIG. 2, wherein an air storage 201 is upstream of the wind tunnel and supplies high pressure air to a heater 202. This heater heats the air and accelerates it through a sonic throat 203 where the air reaches supersonic speeds. It accelerates through the throat as it widens into the test section 204 where the tested item 205 (here, an engine) can be placed. The high speed air then decelerates out the ejector/diffuser 206.

Certain embodiments of the present disclosure include a new and novel manner of supplying a supersonic wind tunnel for sufficient periods for improved testing of materials exposed to supersonic airflow via, for instance, high Mach number flight by, e.g., utilizing geologic gas storage volumes to supply compressed air to supersonic wind-tunnels in order to achieve longer duration and at larger scale than is currently possible. There are a number of large scale gas storage methods used by the energy industry to store compressed gases that are also suitable for compressed air storage for wind tunnel applications. Examples include solution-mined salt caverns, aquifers, sealed rock mines, and deep ocean or lake cavities. Solution-mined salt caverns, in particular, are commonly found as byproducts of industrial processes when recovering carbons from the earth, such as in the gas and oil industry for storage of gas products and disposal of oil field waste. Salt deposits are commonly associated with oil deposits. The gas and oil industry has used these salt deposits for a number of applications.

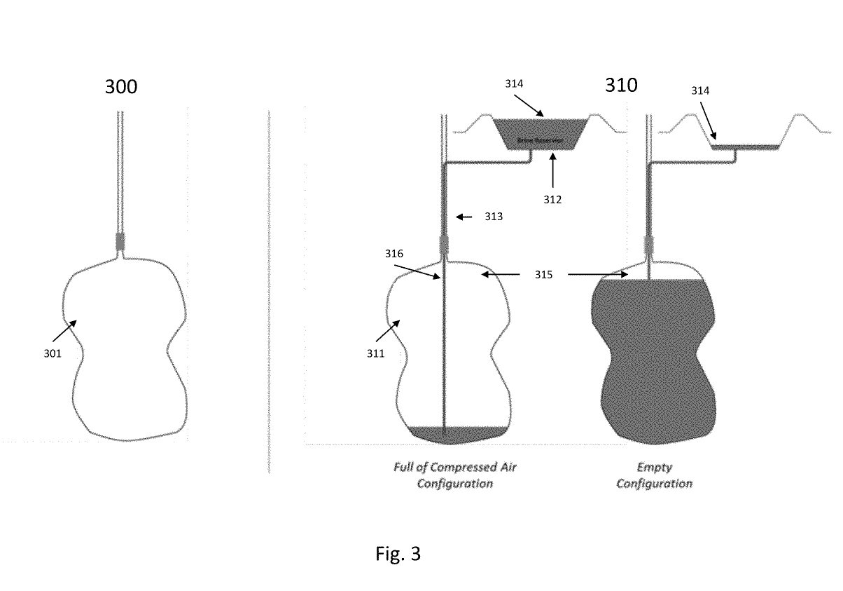

In some embodiments as shown in FIG. 3, solution-mined salt caverns 301 are made by mining of various salts by dissolving them and pumping the resulting brine to the surface. Actual dissolution and recovery methodology is predicated on the solubility of the targeted salt, A “rule of thumb” in the solution mining industry is that every 7-8 cubic meter of freshwater pumped into a cavity will dissolve 1 cubic meter of salt. If saline or brackish water is used for solution mining, the water requirements can be greater. Water or under-saturated brine is injected through a purpose-designed well drilled into a salt mass to etch out a void or cavern. The resulting nearly saturated brine is then extracted for processing. In some embodiments, the technique targets salts at depths greater than 400-500 m and down to 2,000 m. Owing to its favorable geomechanical properties, rock salt remains stable over long periods of time without support, and it can be shown that the geological barrier of the host rock remains intact for a remarkably long time.

In some embodiments, the integrity of the well and salt cavern system is maintained and monitored to ensure long-term, reliable service and safety of the public and to the environment. Periodic integrity assessments include the condition of the wellhead, the cemented production casing, the size and shape of the cavern, and the ability of the cavern system to contain the liquid stored within it. These objectives are associated with corresponding design and construction requirements. The design process seeks to find the most effective combination of performance objectives and design, construction, and operational requirements.

In some embodiments, the roof of the cavern are established deep enough to accomplish the following: a) Having sufficient salt back to ensure adequate roof support of the overburden. b) In bedded formations, the strength of an impervious, overburden layer may be used to provide roof support. c) In domal formations, the cemented production string should be deep enough to adequately seal in the salt below the caprock. In some embodiments, the depth of the production string is a minimum of 300 feet below the top of the salt. The cavern roof should be below the casing seat. d) The production casing seat depth shall be set so that the maximum cavern operating pressure does not exceed the formation fracture gradient or as limited by regulation. The cavern bottom should not be set excessively deep because temperature increases with depth. As temperature increases, so do salt-creep rates and, therefore, closure rates. With displacement caverns, depth also increases the pressure required to inject into the cavern. Theoretically, a spherical cavern is the most stable cavern shape. An inverted cone shape and arched roof is generally considered an acceptable alternative. While the arched shape of the roof is preferred, flat roof caverns can be designed to have adequate strength and integrity.

In some embodiments, setting the required cavern volume should be based on the overall logistics plan for the stored air, including provisions for fluctuating demand and supply or delays or restrictions. Storage cavern capacity normally is stated on a volumetric basis, such as by barrel. With air, as a highly compressible fluid, where density varies with pressure and temperature, consideration should be given to using a design based on mass. Where the storage pressure greatly affects the storage density, cavern depth will greatly affect the mass storage capacity of a cavern for a given volume.

In some embodiments, the cement program shall be designed to provide isolation of the storage zone from all sources of porosity and permeability and secure the casing in the borehole. All cemented casing strings shall be cemented to surface in many of these bodies, or otherwise secured so as to isolate any critical area from the spaces around. In some embodiments, cement quality and testing shall meet or exceed API 10A. Laboratory testing should be conducted on all proposed cements and actual mix water. Non-salt saturated cements should include tests for 24, 48, and 72 hour compressive strengths at temperatures expected in the wellbore. Salt saturated cements should include tests for 24, 48, and 120 hour compressive strengths at temperatures expected. Additives to control free water and fluid loss along with possible expanding agents should be considered. An evaluation of an open-hole caliper log can determine excess cement volume. The amount of time to wait after cementing and before any drilling activity can take place inside of the cemented casing is dependent on the development of compressive strength of the cement. The relevant discussion of casing is found throughout this disclosure.

In some embodiments, the two modes of circulating fluids through the cavern system are direct and reverse modes. Both modes require a single well to be equipped with concentric hanging strings. If two or more wells are used, single hanging strings can be set in the multiple wells for use in direct or reverse flow. With direct circulation, raw water is pumped down the longest hanging string (lowest set string) and exits the bottom of the string into the cavern. The raw water then circulates through the cavern by flowing along the walls where it dissolves salt, gains saturation and becomes brine. The brine is removed through the shortest hanging string and out the well. This mode of operation typically results in low saturation of the brine being produced. As this mode of circulation places raw water towards the lower portions of the cavern, direct circulation tends to enlarge the lower portion of the cavern with the end result being a teardrop or pear-shaped cavern. When a cavern is in reverse circulation mode, raw water is injected down the shortest hanging string. The raw water quickly rises towards the top of the cavern and the brine/blanket interface then towards the walls and continues its circulation path back down the walls of the cavern where it dissolves salt, gains saturation and becomes brine. Completing its circulation in the cavern, the brine is removed from the cavern through the longest hanging string and out the well. The increased salt surface area below the water injection point allows for the water to obtain a higher saturation than with direct circulation and results in a higher saturation for any given flow rate. Reverse circulation tends to mostly enlarge the cavern above the water injection point upward to the blanket/brine interface. Since the roof of the cavern is preferentially mined with this method, extra care shall be taken with roof control so that the salt neck below the casing seat is left intact.

In some embodiments, depending on the source of water used for injection, it should be tested for salinity, specific gravity, sand/silt, oxygen content, bacterial activity and dissolved gases (such as oxygen, carbon dioxide, sulfur dioxide). Water sources include, but are not limited to: wells (both fresh and saline), canals, seawater, river water, and recycled water.

In some embodiments, caverns can be placed in-service and later enlarged over time to their maximum size in case the additional air capacity is required for testing. This type of enlargement may occur in the lower interval of the cavern. After a cavern has been placed into service, cavern enlargement may be used to regain volume lost to creep or to attain the maximum cavern volume. Prior to commencing cavern enlargement, the following items should be modeled: the resulting cavern shape; spacing to other caverns, property boundaries, and edge of salt; and review of geomechanical properties. During cavern enlargement, the liquid hydrocarbon-water interface should be closely monitored. The volumes of raw water injected and brine displaced should be compared to a cavern volume table to predict the liquid-brine interface level. Regular interface checks are recommended to verify the liquid water interface and the accumulation of insoluble material. If the liquid hydrocarbon-water interface alters the shape of the cavern roof or has caused solution mining near the casing shoe, a mechanical integrity test shall be performed prior to placing the cavern back into liquid hydrocarbon service. After any significant cavern enlargement, the volume of the enlarged section should be determined by a sonar survey.

In some embodiments, the salinity of the brine being used in storage operations should be tested regularly. An operator will want to establish procedures to monitor salinity based on the specific well configuration and operating conditions at the storage site. Brine can be either supersaturated or under saturated. Supersaturation can occur because of evaporation from the brine storage pond during extended periods of hot, dry weather or when a sudden temperature drop occurs reducing the solubility of salt in water. Supersaturation can result in operating problems usually manifested by precipitation and growth of salt crystals in pump cases, valve bodies, well tubing, etc., causing increased wear and eventual blockage. Consideration should be given to installation of fresh water flushing systems to facilitate the dilution of salt crystals in critical equipment. The operator should also provide fresh water make-up to stored brine during hot, dry weather to maintain salinity at a point slightly less than saturated. Undersaturation can occur naturally due to dilution by rain water or by an increase in temperature thereby increasing the solubility of salt in water, or intentional dilution with fresh water. Under saturated brine has the ability to dissolve salt, which will result in additional cavern growth. This effect should be considered in the operation of mature storage fields or in individual wells where further growth is not desired. Undersaturation also results in a fluid which is less dense than saturated brine and may effect cavern hydraulics.

In some embodiments, brine is stored above ground in open ponds awaiting use for displacement of air from wells. To conserve brine and to prevent environmental pollution of land, surface water, and ground water, the pond should be equipped with an impermeable lining. In selecting a lining material, consideration should be given to compatibility with brine, and ultraviolet deterioration. In some instances a compacted clay lining may be acceptable. The amount of brine storage to be provided relative to the total air storage is dependent on various factors such as the total active storage capacities, the availability of replacement brine (e.g., brine sharing arrangement at multi-company storage areas), and brine disposal capacity. Erosion of external dike walls should be controlled or prevented. Acceptable methods include reducing the slope of the dike walls, planting vegetation suitable to the climate, installing rip rap or environmentally safe stabilized topping, and providing periodic maintenance of the dikes. Wave action in brine storage ponds can cause underliner dike damage or spillage of brine. Maximum fill levels should be established which allow an adequate freeboard to prevent spillage. In cases of severe wave action, consideration should be given to the installation of mechanical wave control. Regulations should be consulted for specific requirements. Brine ponds are exposed to climatic conditions. These include evaporation, dilution, precipitation, and collection of blowing dirt and sand. In the installation of a brine pond, the operator should consider and allow for contraction and expansion of the liner materials under climate extremes with low brine inventories in the pond. Most pond liners are black and collect significant amounts of solar energy resulting in higher brine temperature at the bottom of the pond. Most brine ponds have pump suction at the bottom of the pond. The brine delivered to the well may be supersaturated and at a higher temperature than the brine in the well. The potential effects on air flashing or hydraulic pressure gradient of operating wells should be considered. Piping should be designed to allow fresh water connection to the brine pumps for flushing the suction piping to clear salt from the pump casing and piping

Geologic storage volumes can often be operated in two modes: 1) constant volume, or 2) constant pressure. Variations are possible such that the storage volume is neither constant in volume or pressure. Salt Caverns and Sealed Mines can be operated in each of these modes, while aquifers and underwater methods operate in a constant pressure manner. FIG. 3 illustrates a salt cavern 301, 311 configured for constant volume operation 300 (in the leftmost figure) and constant pressure operation 310 (in the right two figures).

Constant volume storage volume is a simple method. The storage volume is just a container in which air is compressed as it flows into the volume. Upon removal of the air, the pressure continuously drops as air is removed. This embodiment is preferred in some applications and disfavored in some applications. This approach is simple to operate and requires minimum construction and equipment to establish. The constant volume method does not maximize the availability of air in the cavern. Once the pressure within the cavern drops below some point, no more air is available from the cavern.

Constant pressure makes maximum use of the air storage in the cavern. Brine 312 is allowed to flow 313 between a surface reservoir 314 and the cavern 311 to compensate for changes in air volume 315 in the cavern as the high pressure air is piped toward the test section. The pressure of the stored air is constant. Air pressure in the cavern is regulated by the length of the brine column 316 between the cavern 311 and the surface reservoir 314. This type of air cavern is the preferred embodiment for the invention because it maximizes the amount of air stored in the cavern and delivers the air at a constant pressure.

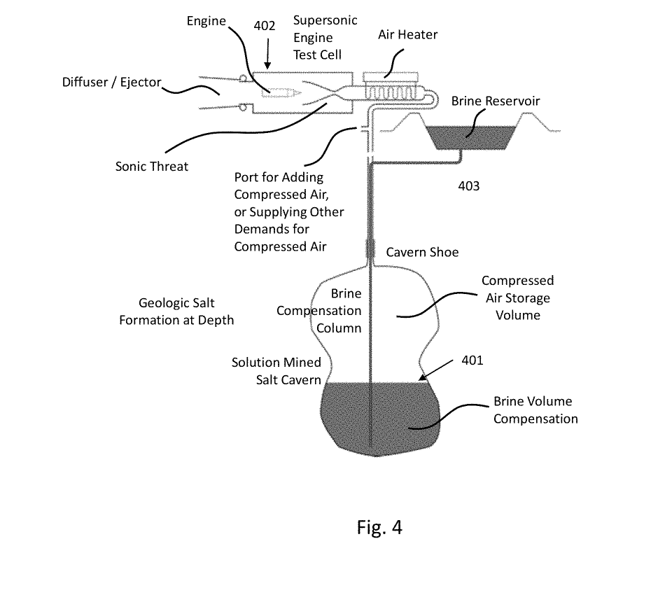

In some embodiments, displacement cavern uses concentric tubing strings to move stored air in or out and the displacement fluid (in some embodiments this fluid is brine) out or in. During solution mining operations fresh water moves in and brine out through concentric tubing strings. Both operations create, in effect, a large U-tube for the flow and because of the differences in densities between the displacement fluid and the air (stored), a manometer is created. In FIG. 4, under static conditions (no flow) the pressure at interface 401 of brine and compressed air, is equal inside and outside the brine string. This pressure equals (d_{b}×hₚ)+P_{c}, where d_{b} is the density of the brine, hₚ is depth of the interface, and P_{c} is the static gauge pressure at the entry of the brine reservoir. P_{c} is referred to as the brine wellhead pressure. It also equals (dₚ×hₚ)+Pₐ, where dₚ is the density of the air, and Pₐ equals the gauge pressure at the entry of air to the heater. Pₐ is referred to as air wellhead pressure. By setting these equally, the static wellhead air pressure can be established as follows:

Pₐ=(d_{b}−dₚ)hₚ+P_{c} (1)

It follows then that the static wellhead pressure of a cavern empty of air is determined by:

Pₑ=(d_{b}−dₚ)hₜ+P_{c} (2)

where Pₑ is the static wellhead pressure for a cavern empty of air at the entry of air to the heater; d_{b} is the density of brine; dₚ is the density of air; hₜ is the depth to top of cavern; P_{c} is the static gauge pressure at the entry of the brine reservoir. A cavern full of air is determined by:

P_{f}=(d_{b}−dₚ)h_{b}+P_{c} (3)

where P_{f} is the static wellhead pressure for a cavern full of air at the entry of air to the heater; d_{b} is the density of brine; dₚ is the density of air; h_{b} is the depth to bottom of brine string; P_{c} is the static gauge pressure at the entry of the brine reservoir. For air as a compressible fluid, the density of air varies considerably from top to bottom, and the mean density must be calculated by iteration. Uncertain and changing air temperatures also reduce the accuracy of such wellhead pressure calculations. The accuracy of the wellhead pressure calculation is dependent on variations in brine gravity and air temperature such that calculated wellhead pressure more accurately should be given as a range for air as a compressible fluid.

In some embodiments, the displacement cavern tubing strings form a U-tube with displacement medium (brine) in one leg and stored air in at least part of the other leg. Flowing pressure drop is associated with cavern tubing strings and requires calculation of the drops in both legs of the U-tube. In some embodiments, the tubing string configuration involves one or two tubing strings hung concentrically within a casing cemented into the salt. Flow in one leg, therefore, will be annular flow. The brine leg calculation involves a straight pipe pressure drop determination.

In some embodiments, the heater is configured to increase the temperature of the gas thought various heat transfer mechanisms, including conduction, convection and radiation. The heater can be in various forms, including but not limited to fan heater, radiant heater, furnace, duct heater. The heater may work with various source of energy including but not limited to wood, solar, oil fractions, coal, natural gas, and electricity.

In some embodiments, air storage volume from geologic formations is used to supply air to a wind tunnel 401. Specifically, a constant pressure, volume compensated, solution mined salt cavern 403 is a preferred air storage volume for a wind tunnel test cell. FIG. 4 is a schematic of a supersonic engine test cell supplied with compressed air stored in, and supplied by, a constant pressure salt cavern.

Salt caverns can be very large, commonly a few 100,000 cubic meters in volume. Many existing caverns have volumes over a million cubic meters. Storage pressure can be over 1.5 MPa per 100 m of depth. Typical salt deposits suitable for solution mining are over 1,000 meters deep. Storage pressures over 15 MPa are common. The pressure and size of salt caverns for compressed air storage is far beyond the capability of above-ground, engineered, pressure vessels. Application of salt caverns will allow wind tunnels to be built at larger scale and have much longer operation periods. For example, GRA is developing a high-speed engine that will have a cruising condition of Mach 5 at 95,000 feet with a mass flow of 50 kilograms a second. The maximum mission duration for this engine will be four hours. By example a test cell, able to test this engine, with a mass flow requirement, at test conditions, of four times the engine's mass flow, 200 kg/sec could be used. For the example, assume a cavern with a volume of 100,000 m³, is pressurized to 15 MPa. This cavern, at 300° K, will hold 17×10⁶ kg of air. At 200 kg/sec, this facility will have a testing duration of up to 24 hours. Twenty four hours is an extended period of time that exceeds comparable supersonic wind tunnels over a similar test section. The volume and pressure available from salt caverns has the potential of meeting future high-speed aircraft testing needs.

Some aspects of this disclosure include a high volume supersonic wind tunnel system comprising: a test cell for supersonic engine having an upstream end and a downstream end; a diffuser having an upstream end and a downstream end, the upstream end disposed adjacent to the downstream end of the test cell; a sonic throat having an upstream end and a downstream end, the downstream end disposed adjacent to the upstream end of the test cell; a heater having an upstream end and a downstream end, the downstream end disposed adjacent to the upstream end of the sonic throat; and a gas storage in communication with the test cell, which is disposed adjacent to an upstream end of the heater, wherein the gas storage is configured to hold high pressure gas and further wherein the gas storage is a subsurface abscess.

Some aspects of this disclosure include the system above, wherein the wind tunnel is configured to provide supersonic speeds up to Mach 5.

Some aspects of this disclosure include the system above, wherein the wind tunnel is configured to provide non-stop operation for at least 2 hours at Mach 5.

Some aspects of this disclosure include the system above, wherein the heater is configured to increase the temperature of the gas through at least conduction, convention or radiation.

Some aspects of this disclosure include the system above, wherein the gas storage is a constant volume container.

Some aspects of this disclosure include a high volume supersonic wind tunnel system comprising: a test cell for supersonic engine, the test cell having an upstream and downstream end; a diffuser having an upstream end and a downstream end, the upstream end of which is disposed adjacent to a downstream end of the test cell; a sonic throat having an upstream and a downstream end, the downstream end of which is disposed adjacent to the upstream end of the test cell; a heater having an upstream end and a downstream end, the downstream end of which is disposed adjacent to the upstream end of the sonic throat; a gas storage, which is in fluid communication with the heater, wherein the gas storage is configured to hold high pressure gas; and a brine reservoir, which is connected to the gas storage via a piping system, wherein the piping system transfers brine to the gas storage to push the high pressure gas out of the gas storage through the upstream end of the heater.

Some aspects of this disclosure include the system above, wherein the gas storage is a subsurface abscess and the brine reservoir is at higher elevation than the gas storage.

Some aspects of this disclosure include the system above, wherein the wind tunnel is configured to provide supersonic speeds up to Mach 5.

Some aspects of this disclosure include the system above, wherein the wind tunnel is configured to provide non-stop operation for at least 2 hours at Mach 5.

Some aspects of this disclosure include the system above, wherein the heater is configured to increase the temperature of the gas through at least conduction, convection or radiation.

Some aspects of this disclosure include the system above, wherein the gas storage is at a constant pressure and the pressure of the gas storage is regulated by applied pressure from piping system of brine, wherein the pressure is applied by at least one of external pumping or gravity force of brine being at higher height compared to the gas storage.

Some aspects of this disclosure include the system above, wherein the brine fills the gas storage from the bottom portion of the gas storage and the high pressure gas exits the gas storage from the upper portion of the gas storage.

Some aspects of this disclosure include the system above, wherein the brine is configured to be pumped back to the brine reservoir to refill the gas storage with compressed gas.

Some aspects of this disclosure include a method of operating a wind tunnel at supersonic speeds to study performance of a supersonic engine, comprising the steps of: placing the supersonic engine in a test cell; blowing air at supersonic speeds to the supersonic engine, wherein the wind tunnel comprises: a diffuser having an upstream end and a downstream end, the upstream end of which is disposed adjacent to a downstream end of the test cell; a sonic throat having an upstream end and a downstream end, the downstream end of which is disposed adjacent to the upstream end of the test cell; a heater having an upstream end and a downstream end, the downstream end of which is disposed adjacent to the upstream end of the sonic throat; a gas storage, which is disposed in fluid communication with the heater, wherein the gas storage is configured to hold high pressure gas; and a brine reservoir having brine, which is in fluid communication with the gas storage via a piping system, wherein the piping system transfers brine to the gas storage to push the gas out of the storage through the upstream end of the heater.

Some aspects of this disclosure include the method above, wherein the gas storage is a subsurface abscess and the brine reservoir is placed at higher height than the gas storage.

Some aspects of this disclosure include the method above, wherein the wind tunnel is configured to provide supersonic speeds up to Mach 5.

Some aspects of this disclosure include the method above, wherein the wind tunnel is configured to provide non-stop operation for at least 2 hours at Mach 5.

Some aspects of this disclosure include the method above, wherein the heater is configured to increase the temperature of the gas through at least conduction, convention or radiation.

Some aspects of this disclosure include the method above, wherein the gas storage is at a constant pressure and the pressure of the gas storage is regulated by applied pressure from piping system of brine, wherein the applied pressure is caused by at least external pumping or gravity force of brine being at higher height compared to the gas storage

Some aspects of this disclosure include the method above, wherein the brine fills up the gas storage from the bottom and pushes the gas to exit from top of the gas storage.

The reader should appreciate that the present application describes several inventions. Rather than separating those inventions into multiple isolated patent applications, the applicants have grouped these inventions into a single document because their related subject matter lends itself to economies in the application process. Nonetheless, the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art of reviewing this disclosure the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, (i.e., encompassing both “and” and “or.”) Terms describing conditional relationships (e.g., “in response to X, Y,” “upon X, Y,” “if X, Y,” “when X, Y,” and the like), encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”.) Such conditional relationships are not limited to consequences that instantly follow the antecedent obtaining, as some consequences may be delayed, and in conditional statements, antecedents are connected to their consequents, (e.g., the antecedent is relevant to the likelihood of the consequent occurring). Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y,”) in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category.

What is claimed is:

1. A high volume supersonic wind tunnel system comprising:
a test cell for supersonic engine having an upstream end and a downstream end;
a diffuser having an upstream end and a downstream end, the upstream end disposed adjacent to the downstream end the test cell;
a sonic throat having an upstream end and a downstream end, the downstream end disposed adjacent to the upstream end of the test cell;
a heater having an upstream end and a downstream end, the downstream end disposed adjacent to the upstream end of the sonic throat; and
a gas storage in communication with the test cell, which is disposed adjacent to an upstream end of the heater, wherein the gas storage is configured to hold high pressure gas and further wherein the gas storage is a subsurface abscess.

2. The system of claim 1, wherein the wind tunnel is configured to provide supersonic speeds up to Mach 5.

3. The system of claim 1, wherein the wind tunnel is configured to provide non-stop operation for at least 2 hours at Mach 5.

4. The system of claim 1, wherein the heater is configured to increase the temperature of the gas through at least conduction, convention or radiation.

5. The system of claim 1, wherein the gas storage is a constant volume container.

6. A high volume supersonic wind tunnel system comprising:
a test cell for supersonic engine, the test cell having an upstream and downstream end;
a diffuser having an upstream end and a downstream end, the upstream end of which is disposed adjacent to a downstream end of the test cell;
a sonic throat having an upstream and a downstream end, the downstream end of which is disposed adjacent to the upstream end of the test cell;
a heater having an upstream end and a downstream end, the downstream end of which is disposed adjacent to the upstream end of the sonic throat;
a gas storage, which is in fluid communication with the heater, wherein the gas storage is configured to hold high pressure gas; and
a brine reservoir, which is connected to the gas storage via a piping system, wherein the piping system transfers brine to the gas storage to push the high pressure gas out of the gas storage through the upstream end of the heater.

7. The system of claim 6, wherein the gas storage is a subsurface abscess and the brine reservoir is at higher elevation than the gas storage.

8. The system of claim 6, wherein the wind tunnel is configured to provide supersonic speeds up to Mach 5.

9. The system of claim 6, wherein the wind tunnel is configured to provide non-stop operation for at least 2 hours at Mach 5.

10. The system of claim 6, wherein the heater is configured to increase the temperature of the gas through at least conduction, convection or radiation.

11. The system of claim 6, wherein the gas storage is at a constant pressure and the pressure of the gas storage is regulated by applied pressure from piping system of brine, wherein the pressure is applied by at least one of external pumping or gravity force of brine being at higher height compared to the gas storage.

12. The system of claim 6, wherein the brine fills the gas storage from the bottom portion of the gas storage and the high pressure gas exits the gas storage from the upper portion of the gas storage.

13. The system of claim 6, wherein the brine is configured to be pumped back to the brine reservoir to refill the gas storage with compressed gas.

14. A method of operating a wind tunnel at supersonic speeds to study performance of a supersonic engine, comprising the steps of:
placing the supersonic engine in a test cell;
blowing air at supersonic speeds to the supersonic engine, wherein the wind tunnel comprises:
a diffuser having an upstream end and a downstream end, the upstream end of which is disposed adjacent to a downstream end of the test cell;
a sonic throat having an upstream end and a downstream end, the downstream end of which is disposed adjacent to the upstream end of the test cell;
a heater having an upstream end and a downstream end, the downstream end of which is disposed adjacent to the upstream end of the sonic throat;
a gas storage, which is disposed in fluid communication with the heater, wherein the gas storage is configured to hold high pressure gas; and
a brine reservoir having brine, which is in fluid communication with the gas storage via a piping system, wherein the piping system transfers brine to the gas storage to push the gas out of the storage through the upstream end of the heater.

15. The method of claim 14, wherein the gas storage is a subsurface abscess and the brine reservoir is placed at higher height than the gas storage.

16. The method of claim 14, wherein the wind tunnel is configured to provide supersonic speeds up to Mach 5.

17. The method of claim 14, wherein the wind tunnel is configured to provide non-stop operation for at least 2 hours at Mach 5.

18. The method of claim 14, wherein the heater is configured to increase the temperature of the gas through at least conduction, convention or radiation.

19. The method of claim 14, wherein the gas storage is at a constant pressure and the pressure of the gas storage is regulated by applied pressure from piping system of brine, wherein the applied pressure is caused by at least external pumping or gravity force of brine being at higher height compared to the gas storage

20. The method of claim 14, wherein the brine fills up the gas storage from the bottom and pushes the gas to exit from top of the gas storage.
